(19) United States
(12) Patent Application Publication
(10) Pub. No.: US 2026/0010857 A1
(43) Pub. Date: Jan. 8, 2026

(54) SYSTEMS AND METHODS FOR PROVIDING SINGLE BUSINESS ANALYTICS REPORT

(71) Applicant: Ron Yousif Asmar, West Bloomfield, MI (US)

(72) Inventor: Ron Yousif Asmar, West Bloomfield, MI (US)

(21) Appl. No.: 18/762,506

(22) Filed: Jul. 2, 2024

(51) Int. Cl. G06Q 10/0639; G06Q 50/16

(52) U.S. Cl. CPC G06Q 10/06393; G06Q 30/0201; G06Q 50/16

(57) ABSTRACT

A system and method for providing single business location analytics report are provided. The system and method comprises an analytics report for a single business location that incorporates, but not limited to, foot traffic data and/or business revenues. The system and method further comprises an analytics reports via real estate platform, analytics provider's platform and/or standalone platform. Platform may include website and/or mobile application.

### INTRODUCTION

The present disclosure relates to a system and method of providing single business analytics report. Business analytics report may include, but not limited to, foot traffic data, revenues, retail sales, ranking of chain and/or franchise within local, state or country, and among neighboring similar businesses. Foot traffic data typically includes visits, visitors and/or visitor frequency.

Existing business analytics reports typically includes access to all businesses and typically catered to larger real estate brokers and/or agents on an annual subscription basis. For example, placer.ai™ offers access to foot traffic reports for all businesses in the United States based an annual subscription basis typically costing ˜$3,000. In addition, placer.ai™ offer access to “retail sales/revenues” reports to all businesses in the United States for an additional ˜$5,000 annual subscription fee. Most real estate brokers, agents, sellers and/or buyers do not need access to all business analytics reports in the country. Furthermore, most real estate brokers, agents, sellers and/or buyers simply may not afford to subscribe to ˜$3,000 to $8,000 annual subscription costs. Brokers and/or agents might not be able to pass on the annual subscription costs to their client. While placer.ai™ 's annual subscription fee provides access to most, if not all, businesses in the United States, there is a need to provide single business analytics report at significantly lower cost that is catered to all brokers, agents, sellers and/or buyers. Typically, a buyer/investor is looking to purchase a single investment opportunity and likely not willing to pay an annual subscription fees of ˜$3,000 to $8,000. Sellers are also not willing to pay excessive annual fees to list their business. Similar situation arises with broker and/or agents where they may not be able to recoup their annual subscription costs of ˜$3,000 to $8,000.

CREXI™ Real Estate Company offers their intelligence demographics report at $299 per month; however, CREXI™ reports do not include foot traffic nor business revenues data. Foot traffic and Sales Report data are typically considered critical information in assessing the value of a business. Foot Traffic data and business revenues helps an interested buyer assess the value of a business as part of their purchase consideration. While single business analytics reports have been available, as part of annual subscription, for several years, companies such as placer.ai™ have yet to make single standalone business analytics reports available to brokers, agents, sellers, buyers and/or the large public. To further promote the business, listing broker, agent and/or seller may include the single business analytics report as part of the real estate listing. To further assess the value of a particular business, buyer's broker, agent and/or buyer may purchase single business analytics report. Most buyers are willing to purchase, at a reasonable price, single business analytics report for a business location they are interested in acquiring. For example, a buyer interested in purchasing a business location may be willing to purchase analytics report for that business location at few hundred of dollars; however, likely not willing to pay ˜$3,000-$8,000 to acquire access to same information Today, such buyer would have to spend ˜$8,000 annual subscription cost to obtain such report . . . . While the ˜$8,000 annual subscription costs provides analytics reports for majority or all businesses across the country, these large costs do not fit the needs of most brokers, agents, sellers and/or buyers.

### SUMMARY

Thus, while current analytics reports provided by companies such as placer.ai™ may work for larger brokerage firms or larger real estate companies, there is a need for a new system and method to provide single business analytics reports that caters to all brokers, agents, sellers, buyers and the large public. Since there will likely greater number of customers willing to purchase single business analytic reports, single business reports can be offered at significantly lower costs than ˜$3,000-$8,000 annual subscriptions that provides access to all businesses in the country.

Business analytics reports may include, but not limited to: foot traffic data, revenue data, chain ranking, franchise ranking, comparison to other nearby like businesses, visit frequency, average dwell time, average ticket size and/or year over year comparisons. Single business analytics reports may also be compiled by hourly, weekly, monthly or annually.

Similar to CARFAX™ or AutoCheck™ for acquiring single vehicle reports, this disclosure provides single business analytics report for a single business. Businesses may include retail, office, service, hospitality and other businesses where patrons visit.

According to one aspect of the disclosure, a system and method of purchasing a single business analytics report on a real estate platform such as CREXI™, LoopNet™, Marcus & Millichap™ and/or other real estate firms. These real estate website are generally available to the public at large. To further promote the business, a listing broker, agent, and/or seller may elect to purchase the single business analytics report and include such report as part of the real estate listing.

Another aspect of the disclosure is where an individual or entity interested in a particular business listing may click on a button or link on the listing page to purchase such analytics report for that particular business.

Another aspect of the disclosure, a system and method of providing multiple business analytics report at a discounted price. One example is that a user may be able to purchase 5 business reports at a discounted price and can elect to use each report independently.

Another example is for user to select purchasing either a basic or advanced report. Basic report may include limited historical data such as foot traffic of the business location for the past 6 months; while advanced report may incorporate complete historical data as well as incorporate full revenues data.

In another example, user may be able to purchase advanced report containing more data than a basic report. Advanced report may contain business chain or franchise ranking of foot traffic within city, state or country. Advanced report may also contain data for other nearby like businesses. Advanced report may contain foot traffic by hourly, week days, and by month. Advanced report may also contain complete historical foot traffic data.

In another example user may be able to purchase an advanced report that also incorporates revenue data. Revenue data for the business location may be summarized by hourly, weekday, month to month and year to year comparison. Advanced report may also include business location sales ranking within the state or nationally as compared to other businesses within the chain or franchise.

In another example, advanced report may include average ticket size or average sales transaction by month or by year.

In another example, user may be able to purchase analytics report of the selected business location as well as analytics report of nearby like businesses.

In another example, user may be able to purchase analytics report of all the businesses in a shopping center and/or strip mall.

In another example, user may be able to purchase analytics report of the selected business location and other like businesses within a prescribed area; example: ¼ mile radius.

In another example, user may be able to purchase a subscription, on a daily, weekly or monthly basis, incorporating basic report and/or advanced reports. Such limited subscriptions may be bundled with other services provided by the host.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a sample commercial real estate listing on CREXI™ depicting an analytics report hyperlink button in accordance with one aspect of the present disclosure.

FIG. 2 is a table describing what may be included in the Basic Report and Advanced Report for the analytics reports.

FIG. 3 is a sample system and method illustrating steps for a buyer's broker, agent and/or buyer for acquiring business analytics report.

FIG. 4 is a sample system and method illustrating steps for a listing broker, agent and/or seller for acquiring business analytics report.

FIG. 5 is a sample system and method illustrating steps for acquiring business analytics report from a separate website or mobile app.

FIG. 6 is a sample system and method illustrating steps for acquiring business analytics report directly from business analytics provider.

FIG. 7 is a system and method illustrating the connections between the Real Estate Platform and Business Analytics Provider.

FIG. 8 is a system and method illustrating the connections between a Standalone Platform and Business Analytics Provider.

### DETAILED DESCRIPTION

The following description is merely exemplary in nature and is not intended to limit the present disclosure, application, or uses.

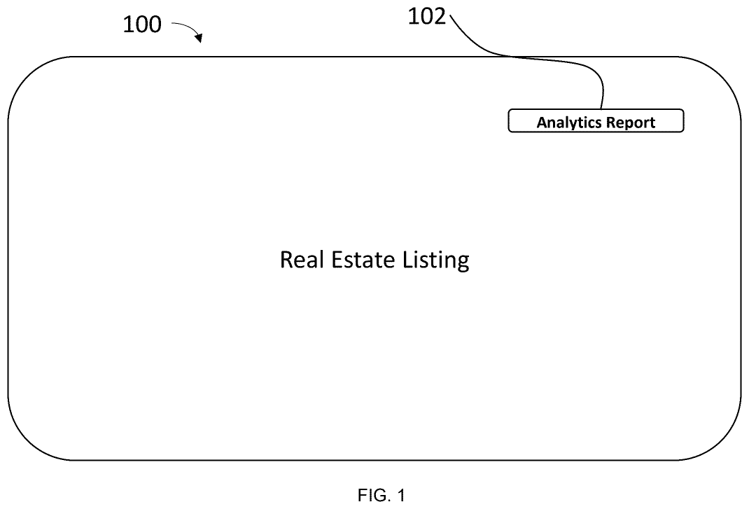

FIG. 1 illustrates a system and method 100 of purchasing a single business analytics report for a business location that is depicted in FIG. 1 in accordance with one aspect of the present disclosure. User may click 102 to select type of business analytics report to acquire.

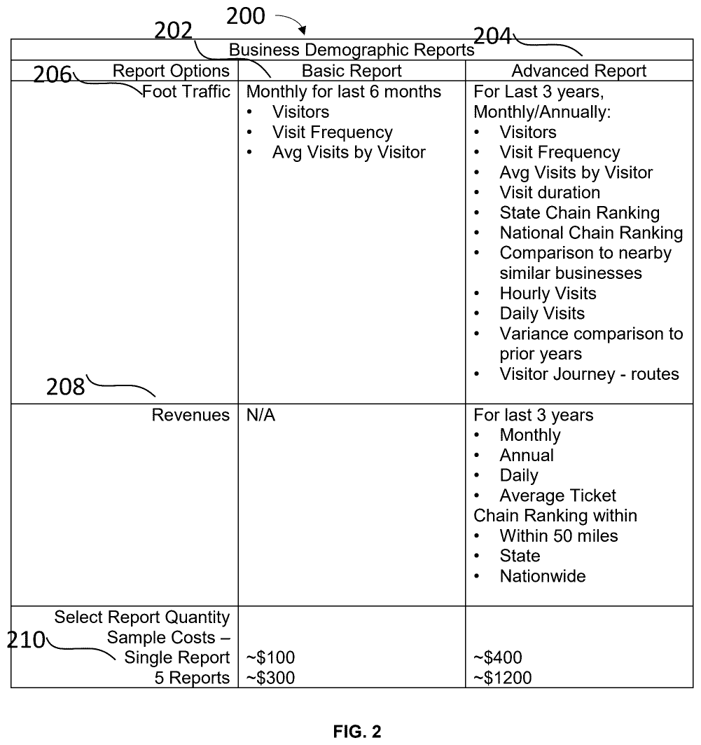

FIG. 2 illustrates a system and method 200 which comprises a selection of a basic or advanced report option for purchase. In this example, the business analytic report options consist of a typical basic report or advanced report. User may select 202 basic report or 204 advanced report. Basic report 202 may include limited foot traffic 206 data and no revenues 208 data. Advanced report 204 may include full report for foot traffic 206 data and full revenues 208 report. User may select to acquire single or multiple reports 210 at different costs.

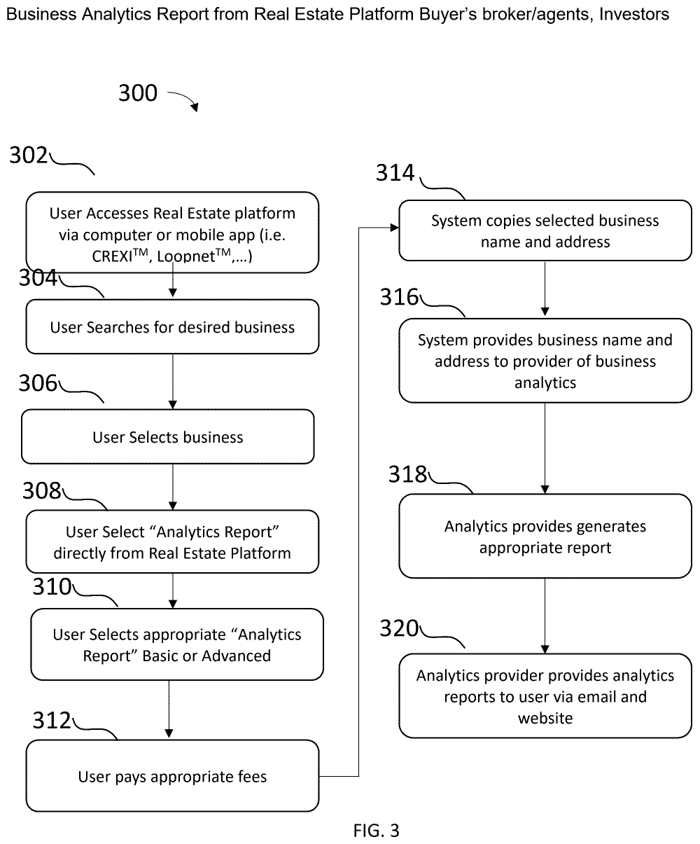

FIG. 3 illustrates a system and method 300 for broker, agent and/or buyer to acquire business analytics report directly from real estate platform such as CREXI™, Loopnet™ or other platforms. User accesses desired real estate platform that supports single business analytics report 302. User searches for desired business location 304. User selects business location that he or she is interested in 306. If interested in business analytics report, user selects “Analytics Report” 308 directly from real estate platform. User may then selects appropriate analytics report 310 (basic, advanced, etc.). User pays appropriate fees for selected report 312 via credit card, debit card or other forms of payments. System copies selected business name and/or address 314. System then provides business name and/or address to business analytics provider 316. Analytics provider generates business analytics report 318. Analytics provider proves appropriate analytics report to user directly via real estate platform and/or user's email 320.

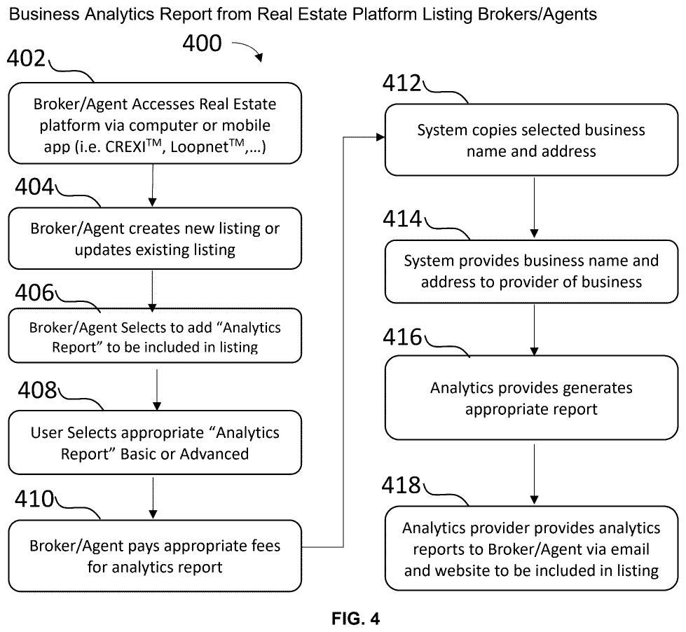

FIG. 4 illustrates a system and method 400 for listing broker, agent and/or seller to acquire single business location analytics report directly from their preferred real estate platform such as CREXI™, Loopnet™ or other platforms. User, such as broker, agent and/or seller, accesses desired real estate platform that support single business location analytics report 402. User creates new listing or updates existing listing 404. User selects appropriate business analytics report to be included as part of the listing 406. User selects appropriate analytics report such as basic or advanced in this example 408. User pays appropriate fees, if necessary, to be included as part of listing 410. System copies selected business name and/or address 412. System then provides business name and/or address to business analytics provider 414. Analytics provider generates business location analytics report 416. Analytics provider provides appropriate analytics report to user directly via real estate platform and/or user's email 418.

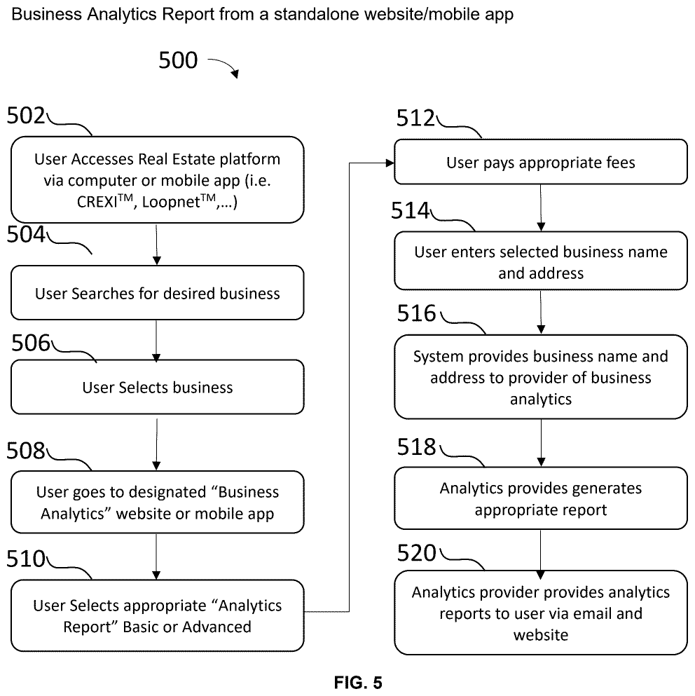

FIG. 5 illustrates a system and method 500 for business analytics report to be acquired directly from a standalone website and/or mobile app. User accesses desired real estate platform 502. User searches for desired business location 504. User selects business listing of interest 506. User then goes to designated business analytics website or mobile app 508. User selects appropriate analytics report 510. User pays appropriate fees 512. User enters selected business name and/or address 514. System provides business name and/or address to business analytics provider 516. Analytics provider generates business location analytics report 518. Analytics provider provides appropriate analytics report to user directly via real estate platform and/or user's email 520.

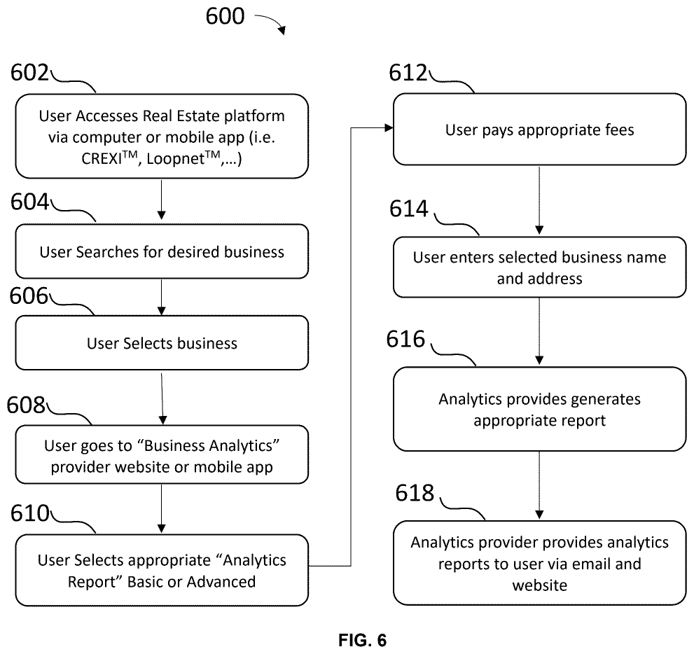

FIG. 6 illustrates a system and method 600 for business analytics report to be acquired directly from business analytics provider's website or mobile app. User accesses desired real estate platform 602. User searches for desired business location 604. User selects business location of interest 606. User then goes to business analytics provider's website or mobile app 608. User selects appropriate analytics report 610. User pays appropriate fees 612. User enters selected business name and/or address 614. Analytics provider generates business location analytics report 616. Analytics provider provides appropriate analytics report to user directly via real estate platform and/or user's email 618.

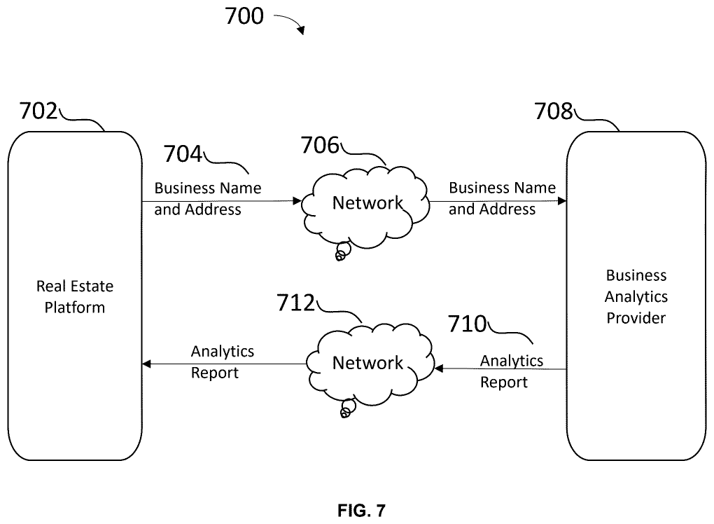

FIG. 7 illustrates a system and method 700 connecting a real estate platform 702 to a business analytics provider 708 over a network 706, 712. Business name and/or address 704 is provided from the real estate platform 702 to a business analytics provider 708 over a network 706. After receiving business name and/or address 704, business analytics provider 708 generates analytics report 710 and provides report to real estate platform 702 over network 712.

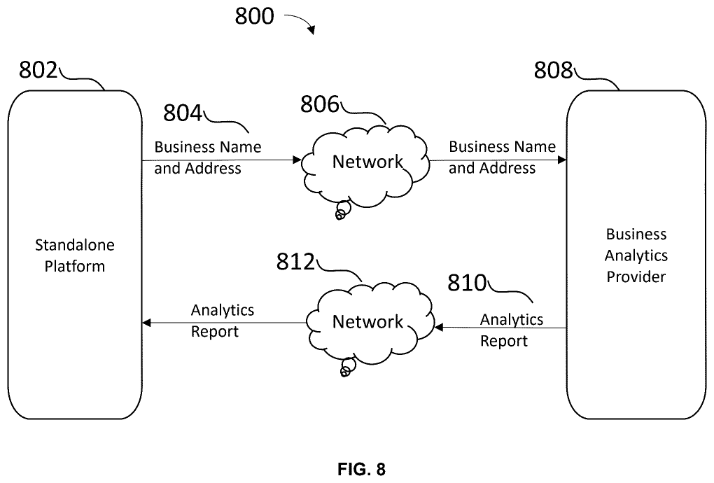

FIG. 8 illustrates a system and method 800 connecting a standalone platform 802 to a business analytics provider 808 over a network 806, 812. Business Name and/or address 804 is provided from the standalone platform 802 to a business analytics provider 808 over a network 806. After receiving business name and/or address 804, business analytics provider 808 generates analytics report 810 and provides report to standalone platform 802 over network 812.

It is to be understood that other system and methods of providing business analytics report may be included without departing from the spirit or scope of the present invention.

The source of business analytics reports data may be procured from 3^{rd} party companies such as placer.ai™ or other companies providing similar service.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method of providing business analytics report comprising a business analytics data for a single business location, the business analytics report incorporating analytics data for at least 2 months.

2. The method of claim 1 wherein the analytics report incorporates foot traffic data.

3. The method of claim 1 wherein the analytics report incorporates business revenue data.

4. The method of claim 1 wherein the analytics report incorporates business performance ranking among other businesses within a chain, franchise or both.

5. The method of claim 1 wherein the analytics report incorporates business performance ranking among nearby similar businesses.

6. The method of claim 1 wherein the analytics report incorporates analytics data by weekday.

7. The method of claim 1 wherein the analytics report incorporates analytics data by hourly visits.

8. The method of claim 1 wherein analytics reports may include average ticket size.

9. The method of claim 1 wherein the analytics report is provided on a real estate platform.

10. The method of claim 1 wherein the analytics report is provided on a standalone website.

11. A system of providing business analytics report comprising a business analytics data for a single business, the business analytics report incorporating analytic data for at least 2 months.

12. The system of claim 11 wherein the analytics report incorporates foot traffic data.

13. The system of claim 11 wherein the analytics report incorporates business revenue data.

14. The system of claim 11 wherein the analytics report incorporates business performance ranking among other businesses within a chain, franchise or both.

15. The system of claim 11 wherein the analytics report incorporates business performance ranking among nearby similar businesses.

16. The system of claim 11 wherein the analytics report incorporates analytics data by weekday.

17. The system of claim 11 wherein the analytics report incorporates analytics data by hourly visits.

18. The system of claim 11 wherein analytics reports may include average ticket size.

19. The system of claim 11 wherein the analytics report is provided on a real estate platform.

20. The system of claim 11 wherein the analytics report is provided on a standalone website.
